(19) United States
(12) Patent Application Publication
(10) Pub. No.: US 2023/0116614 A1
(43) Pub. Date: Apr. 13, 2023

(54) DETERMINISTIC NETWORKING NODE

(71) Applicant: Intel Corporation, Santa Clara, CA (US)

(72) Inventors: Zhongjie SHI, Shanghai (CN); Huifeng LE, Shanghai (CN)

(21) Appl. No.: 18/079,512

(22) Filed: Dec. 12, 2022

(30) Foreign Application Priority Data
Nov. 9, 2022 (CN) PCT/CN2022/130840

(51) Int. Cl. H04L 45/24; H04L 47/28; H04L 45/50

(52) U.S. Cl. CPC H04L 45/24; H04L 47/28; H04L 45/50

(57) ABSTRACT

Examples described herein relate to at least one network interface device that comprises circuitry to perform Deterministic Networking (DetNet) packet forwarding operations; at least one input port; at least one output port; and a bus that is to provide communications, at a quality of service (QoS), among the network interface device, the at least one input port, and the at least one output port. In some examples, a number of network interface devices, a number of input ports, and a number of output ports are based on an amount of DetNet traffic to process prior to transmission.

### RELATED APPLICATION

This application claims priority to PCT/CN2022/130840, filed Nov. 9, 2022. The entire contents of that application are incorporated by reference in its entirety.

### BACKGROUND

Deterministic Networking (DetNet) is an emerging technology that provides a capability to carry specified data flows for real-time applications with low data loss rates, low packet delay variation (jitter), and bounded latency. Applications of DetNet include audio and video streaming, cloud gaming, industrial automation, vehicle control, in-vehicle network, etc. Various DetNet standards have been proposed such as Internet Engineering Task Force (IETF) RFC 8655 (2019) and RFC 8938 (2020). DetNet operates at the Internet Protocol (IP) (layer 3) based on Software-Defined Networking (SDN) to provide Integrated Services (IntServ) and Differentiated Services (DiffServ) integration, and delivers service over layer 2 bridged segments using technologies such as Multi-protocol Label Switching (MPLS) and Time-Sensitive Networking (TSN), described in the IEEE 802.1 series of standards.

### BRIEF DESCRIPTION OF THE DRAWINGS

FIG. 1 depicts an example system.

FIG. 2 depicts an example of a DetNet node.

FIG. 3 depicts an example workflow for configuration of DetNet node and DetNet node forwarding operations.

FIG. 4 depicts an example of scale up for DetNet resource reservation.

FIG. 6 depicts an example so scaling up deterministic capacity on a single node.

FIG. 7 depicts an example process.

FIG. 8 depicts an example network interface device.

FIG. 9 depicts an example system.

### DETAILED DESCRIPTION

In some examples, a DetNet node can be implemented with a network interface device that includes circuitry to provide deterministic networking in accordance with RFC 8655 (2019) and RFC 8938 (2020) based at least on MPLS and TSN technologies. The network interface device can include one or more processors that are configured to execute real-time software (e.g., real time operating system (RTOS) configured by real-time SDN. A bus can connect the network interface device to one or more input ports that can receive packets and provide packets for processing by the network interface device. The bus can connect the network interface device to one or more output ports that can transmit packets received by the input ports or processed by the network interface device. In some examples, the bus provides deterministic latency for communications among devices connected thereto. In some examples, can include one or more network interface devices, one or more input ports, one or more output ports, one or more accelerators, one or more processors, and one or more memory. Available devices and packet processing capability can be scaled-up by connection to the bus. Conversely, available hardware and packet processing capability can be scaled-down by disconnecting hardware from the bus. To scale-up DetNet capabilities, multiple DetNet nodes can be connected together using a network, interconnect, or bus that provides TSN communications among DetNet nodes.

Some examples provide a composable and scalable with modularized design that can support different forms of composition to perform Network Function Virtualization (NFV), Service Function Chains (SFC), etc. as well as changing performance requirements changes (e.g., quality of service (QoS), traffic engineering, etc.) even if the hardware has already been provisioned and deployed. Some example implementations of NFV are described in ETSI specifications or Open Source NFV MANO from ETSI's Open Source Mano (OSM) group. DetNet operations of the network interface device can be configured by software to update configurations such as routing table, policy updates, software over the air (OTA) upgrade, etc.

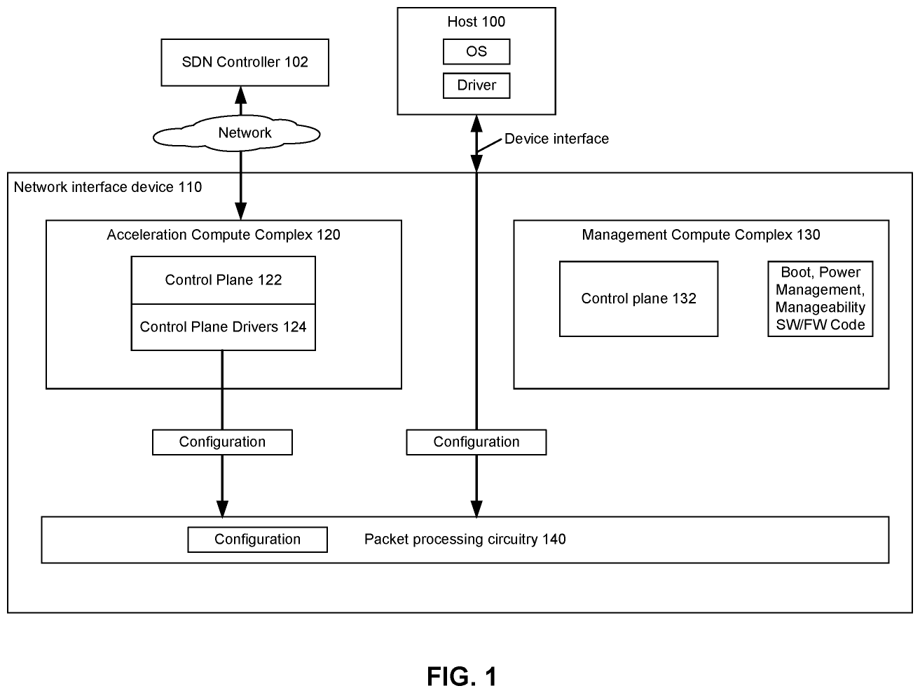

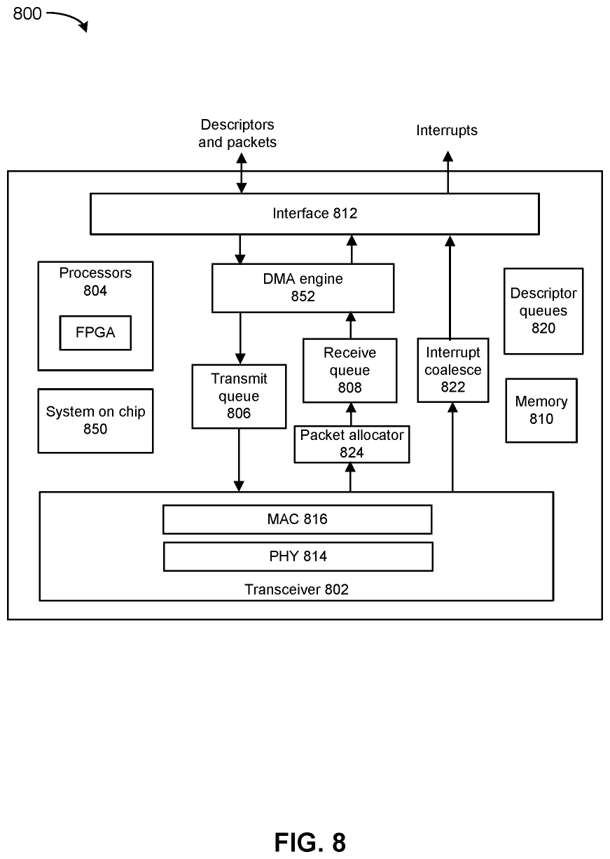

FIG. 1 depicts an example system. Host 100 can include one or more processors, one or more memory devices, one or more device interfaces, as well as other circuitry and software described at least with respect to one or more of FIGS. 8 and/or 9. Processors of host 100 can execute software such as applications (e.g., microservices, virtual machine (VMs), microVMs, containers, processes, threads, or other virtualized execution environments), operating system (OS), and one or more device drivers. For example, an application executing on host 100 can utilize network interface device 110 to receive or transmit packet traffic. An OS or device driver can configure network interface device 110 to utilize one or more control planes to communicate with software defined networking (SDN) controller 102 via a network to configure operation of the one or more control planes.

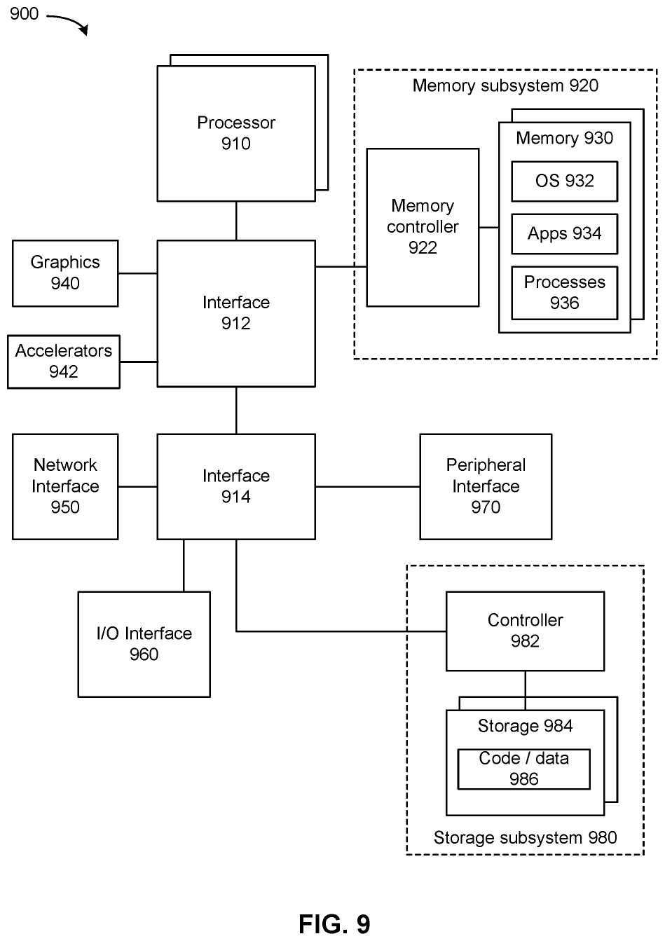

Network interface device 110 can be implemented as one or more of: a microprocessor, processor, accelerator, field programmable gate array (FPGA), application specific integrated circuit (ASIC) or circuitry or software described at least with respect to one or more of FIGS. 9-12. Network interface device 110 can include multiple compute complexes, such as an Acceleration Compute Complex (ACC) 120 and Management Compute Complex (MCC) 130, as well as controller 150, packet processing circuitry 140, and network interface technologies for communication with other devices via a network.

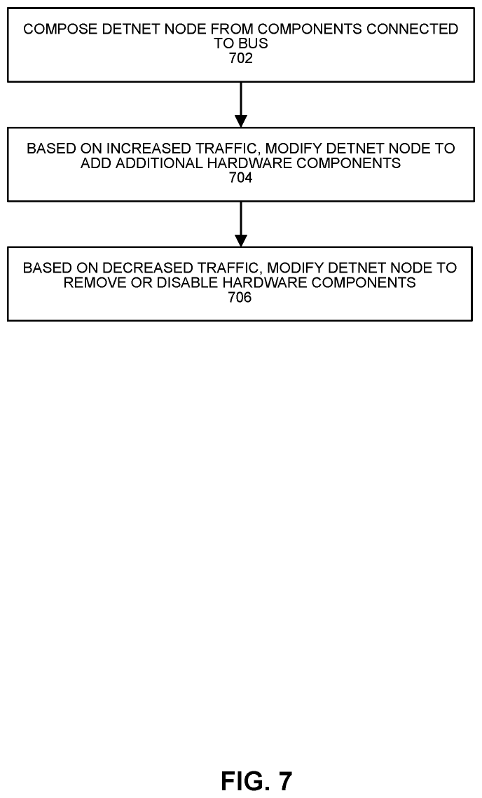

ACC 120 can be implemented as one or more of: a microprocessor, processor, accelerator, field programmable gate array (FPGA), application specific integrated circuit (ASIC) or circuitry described at least with respect to FIGS. 7-9. Similarly, MCC 130 can be implemented as one or more of: a microprocessor, processor, accelerator, field programmable gate array (FPGA), application specific integrated circuit (ASIC) or circuitry described at least with respect to one or more of FIGS. 8 and/or 9. In some examples, ACC 120 and MCC 130 can be implemented as different cores in a CPU, different cores in different CPUs, different processors in a same integrated circuit, or different processors in different integrated circuits.

In some examples, SDN controller 102 can provide rules that control plane 122 executed by ACC 120 is to utilize to configure packet processing circuitry 140. For example, control plane 122 executed by ACC 120 can program table rules (e.g., header field match and corresponding action) applied by packet processing pipeline circuitry 140 based on change in policy and changes in VMs, containers, microservices, applications, or other processes.

Control plane 122 executed by ACC 120 can be configured to provide flow cache rules into a table to configure operation of packet processing pipeline 140. For example, the ACC-executed control plane application 122 can configure rule tables applied by packet processing pipeline circuitry 140 with rules to define a traffic destination based on packet type, flow identifier, and/or content. Control plane 122 executed by ACC 120 can program table rules (e.g., match-action) into memory accessible to packet processing pipeline circuitry 140 based on change in policy and changes in VMs. For example, control plane 122 executed by ACC 120 can configure packet processing pipeline circuitry 140 as to which VM is to receive traffic and what kind of traffic a VM can transmit. In some examples, packet processing pipeline circuitry 140 can execute a virtual switch such as vSwitch or Open vSwitch that provides communications between virtual machines executed by host 100 and network interface device 110.

MCC 130 can execute a host management control plane, global resource manager, and perform configuration of hardware registers. Control plane 132 executed by MCC 130 can perform provisioning and configuration of packet processing circuitry 140. For example, a VM executing on host 100 can utilize network interface device 110 to receive, transmit, or process packet traffic. MCC 130 can execute boot, power, management, and manageability software (SW) or firmware (FW) code to boot and initialize the packet processing device 110, manage the device power consumption, provide connectivity to Baseboard Management Controller (BMC), and other operations.

Host 100 and ACC 120 (or other devices (e.g., MCC 130 and SDN controller 102)) can execute control planes that request configuration of packet processing circuitry 140. One or both of control planes executed by host 100 and ACC 120 can define traffic routing table content and network topology applied by packet processing circuitry 140 to select a path of a packet in a network to a next hop or to a destination network-connected device. Configuration of packet processing circuitry 140 can include configuration of table rules such as match-action entries for particular flow identifiers. Host 100 and ACC 120 can provide configuration by at least one packet or by writing to a queue associated with a source control plane.

Packet processing circuitry 140 can be implemented using one or more of: application specific integrated circuit (ASIC), field programmable gate array (FPGA), processors executing software, or other circuitry. Various examples of packet processing pipeline circuitry 140 are described herein. Control plane 122 and a control plane executed by host 100 can configure packet processing pipeline circuitry 140 or other processors to perform operations related to issuances of non-volatile memory express (NVMe) reads or writes, issuances of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), local area network (LAN) packet transmissions or receipts, compression/decompression, encryption/decryption, configuration as a storage node, configuration as a tenant hosting node, configuration as a compute node, provide multiple different types of services between different Peripheral Component Interconnect Express (PCIe) end points, or other accelerated operations. For example, a control configuration can be applied to high-frequency population use-cases (e.g., connection tracking for disaggregated firewall deployments).

Packet processing circuitry 140 can be configured to perform packet forwarding for network and storage applications, such as cloud native deployments inside of a host node for east-west traffic (e.g., data packets sent server-to-server within a data center). Packet processing circuitry 140 can support a variety of legacy and advanced use-cases extending across Artificial Intelligence (AI), cloud, Network Function Virtualization (NFV), Edge, among others. Application of a Kubernetes service and policy flow can be offloaded to the packet processing pipeline circuitry. Packet processing circuitry 140 can perform load balancing of traffic to Kubernetes or other services.

Packet processing circuitry 140 can perform load balancing, security, and apply network policies for distributed runtime (e.g., microservices, virtual machines, interface to a service mesh, service mesh, containers, service function chains). Network policies can be provided by a tenant, infrastructure provider, service provider used to select entity to service a request.

A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

A flow can include a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be discriminated at a finer granularity by using N-tuples (e.g., source address, destination address, IP protocol, transport layer source port, and destination port), where N-tuple can refer to one or more of: source address, destination address, IP protocol, transport layer source port, and destination port. A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

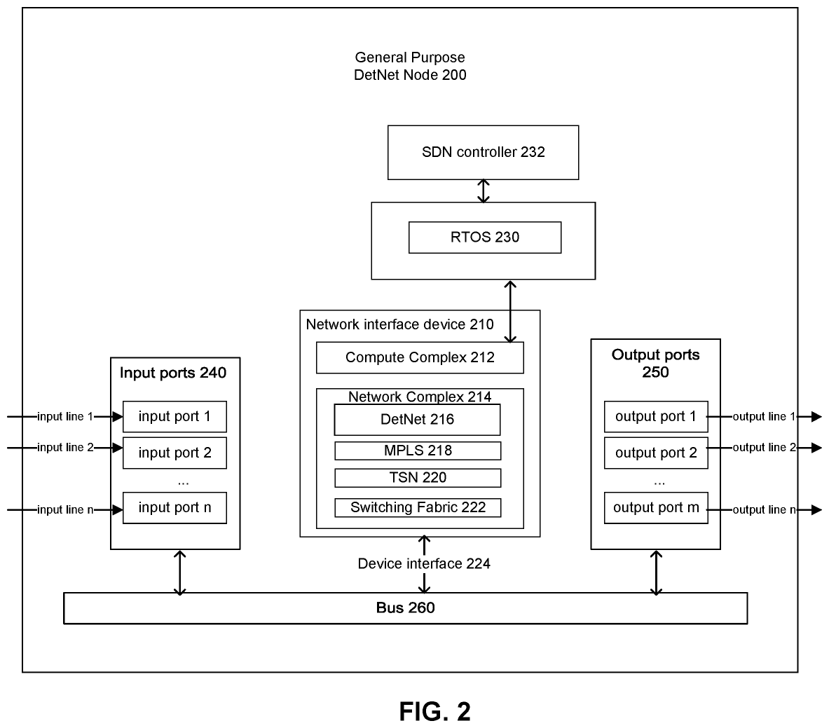

FIG. 2 depicts an example of a DetNet node. Network interface device 210 can include technologies described with respect to FIGS. 8 and/or 9 as well as compute complex 212, network complex 214, and device interface 224. Compute complex 212 can provide general purpose processing which can be also used for routing process. For example, compute complex 212 can execute SDN 232 to provide configurations, switching configurations, and so forth to be applied by components along a data path that includes one or more of: DetNet 216, MPLS 218, TSN 220, switching fabric 222, input ports 240 (or interface to input ports 240), and/or output ports 250 (or interface to output ports 250). For example, compute complex 212 can execute real-time software (RTOS) 230 to configure traffic control by DetNet 216. For example, real-time Infrastructure Programmer Development Kit (IPDK), as well as other frameworks such as Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), eBPF, or others, can support real-time configurations by RTOS 230. In some examples, device interface 224 can be consistent with Peripheral Component Interconnect Express (PCIe), Compute Express Link (CXL), Universal Chiplet Interconnect Express (UCIe), or other connection technologies.

Network complex 214 can be implemented as one or more of: a microprocessor, processor, accelerator, field programmable gate array (FPGA), application specific integrated circuit (ASIC) or circuitry or software. Network complex 214 can include hardware configurable by SDN 232 and RTOS 230 to perform operations for DetNet 216, MPLS 218, Time Sensitive Networking (TSN) 220, and switching fabric 222. To support real-time applications, DetNet 216 can perform reservation of data plane resources in intermediate nodes along a packet flow path, calculation of explicit routes independent of network topology, and/or redistribute data packets to deliver data despite loss of one or more paths. DetNet 216 can perform DetNet standard consistent packet forwarding according to one or more quality of services (QoS) (e.g., RFC 8655 (2019) and RFC 8938 (2020)). For example, DetNet 216 can perform layer 3 operations such as packet forwarding, manage QoS, and forwards host domain messages to a Transport layer (layer 4). MPLS 218 and TSN 220 can provide data communication service to DetNet 216. MPLS 218 and TSN 220 can perform layer 2 operations such as delivery of frames between devices, media access control, flow control and error checking. DetNet 216, MPLS 218, and TSN 218 can be implemented in hardware and can be configured or programmed using software. MPLS 218 can route traffic using a shortest path based on labels rather than network addresses.

Switching fabric 222 can provide switching fabric hardware for packets from input ports 240 to output ports 250 based on software-defined switching configurations from RTOS 230 and/or software defined networking (SDN) 232.

Input ports 240 can receive packets on one or more of input ports 1 to n, where n≥2. Input ports 240 can provide packets to bus 260 for transfer to network interface device 210 and/or output ports 250. Output ports 250 can transmit packets received from bus 260 from input ports 240 and/or network interface device 210 through one or more of output ports 1 to n, where n≥2, however the number of input ports and output ports can be different. Input ports 240 and output ports 250 can be implemented as independent hardware modules that are connected through bus 260. In some examples, input ports 240 can provide received packet headers of ingress traffic to DetNet 216 to determine which output port should be used for forwarding the packets.

Bus 260 can provide deterministic latency such as isochronous data transfer. For example, bus 260 can operate consistent with Peripheral Component Interconnect Express (PCIe), Compute Express Link (CXL), Universal Chiplet Interconnect Express (UCIe), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

As is described herein, DetNet node 200 can be scaled-up or down based on QoS requirements and/or volume of input traffic.

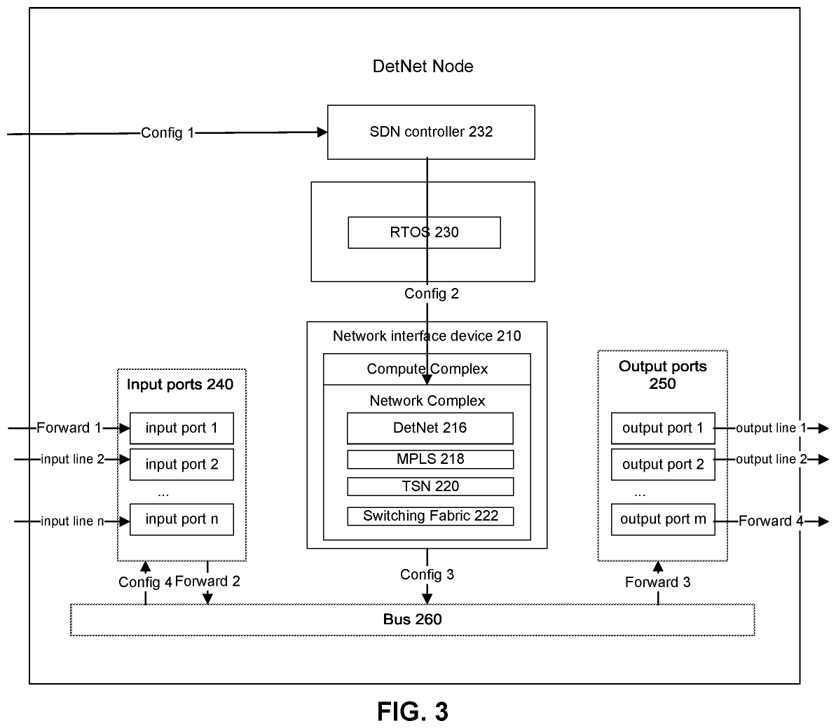

FIG. 3 depicts an example workflow for configuration of DetNet node as well as DetNet node forwarding operations. In a configuration phase, configuration operations can be as follows. At (1) real-time SDN software can receive configurations from centralized control plane. The configuration can include forwarding rules for one or more packet flows. At (2), real-time SDN software can provide the forwarding rules to switching fabric 222. At (3), switching fabric 222 can translate and provide the rules to input ports 240 via bus 260. At (4), input ports 240 can receive forwarding rules and configure a manner of forwarding packets from one or more output ports 250. One or more of input ports 240 and/or output ports 250 can include computing and memory capacity to execute software and/or firmware and store forwarding tables.

After the configuration phase, DetNet Node is ready to serve traffic in a packet forwarding phase. In a packet forwarding phase, operations can be as follows. At (1), input ports 240 receive the ingress traffic from the input lines and enqueue it according to the forwarding rules. At (2), input ports 240 can send the ingress data according to the forwarding rules to output ports 250 via bus 260. At (3), output ports 250 can receive the data (e.g., packet and/or packet payload) from bus 260 forwarded by input ports 240. At (4), output ports 250 can send the packets out to the output lines.

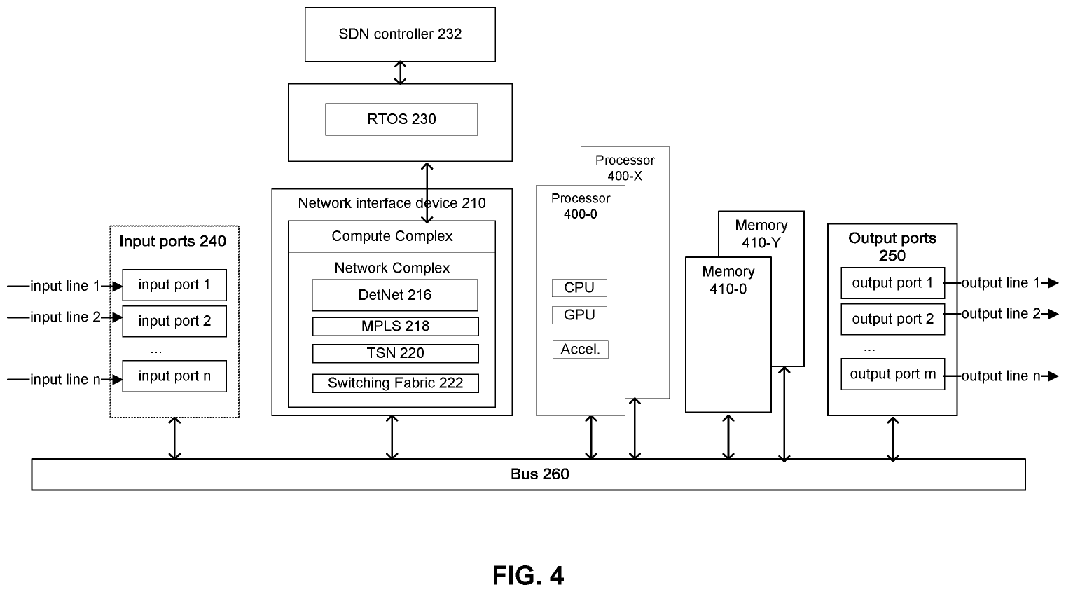

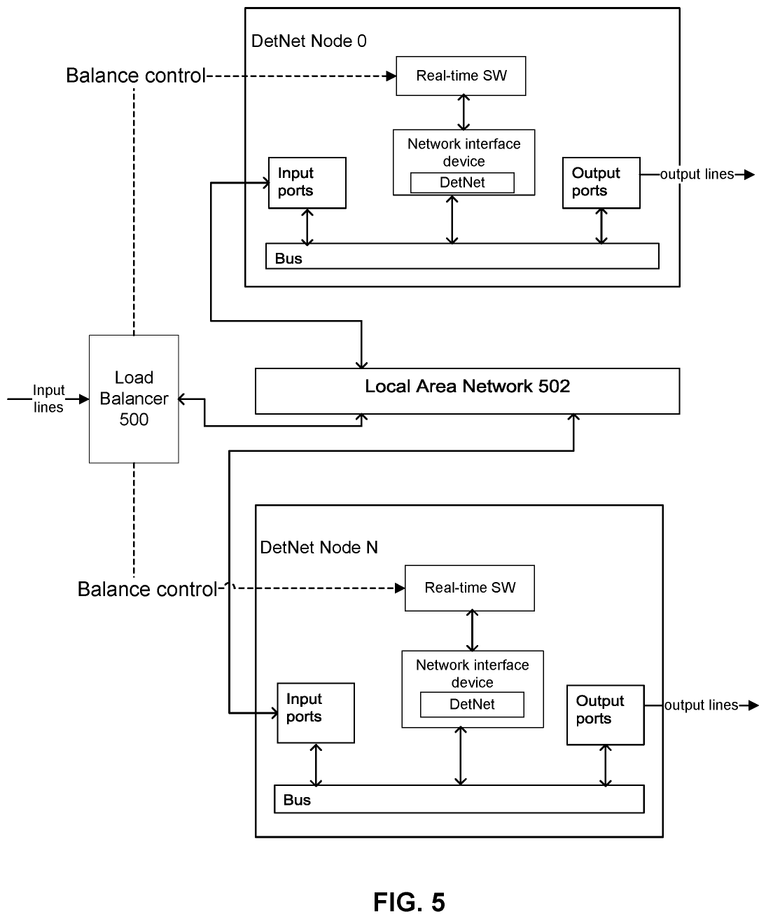

FIG. 4 depicts an example of scale-up of available resources to a DetNet node. Processors 400-0 to 400-X, where X≥1, and memory 410-0 to 410-Y, where Y≥1, can be coupled to bus 260 for access by network interface device 210. For example, one or more of processors 400-0 to 400-X can include one or more of: central processing units (CPUs), graphics processing units (GPUs), accelerators, and other devices. In some examples, a DetNet node can offload non-latency deterministic workload to processors 400-0 to 400-X, and more processor and memory resources on network interface device 210 can be reserved to perform deterministic workloads and more memory could be reserved for routing tables. Examples of deterministic services include communications with a QoS guarantee whereas examples of non-deterministic services include communications that are transmitted according to best efforts or management of forwarding configurations.

FIG. 5 depicts an example of scaling of available DetNet Nodes. In some examples, a group of two or more DetNet nodes can be connected by network 502 with one or more routers that provide a deterministic latency of communications between DetNet nodes. For example, network 502 can operate in accordance with TSN. Load balancer 500 can balance flows among DetNet nodes according to a users' scheduling policies or queueing disciplines. For example, a cluster of DetNet nodes can provide an NFV implementation for DetNet Node and a cluster of DetNet nodes can be accessed as one DetNet node by other nodes connected thereto. A number of DetNet nodes can be scaled up or down by adding or removing DetNet nodes connected to network 502.

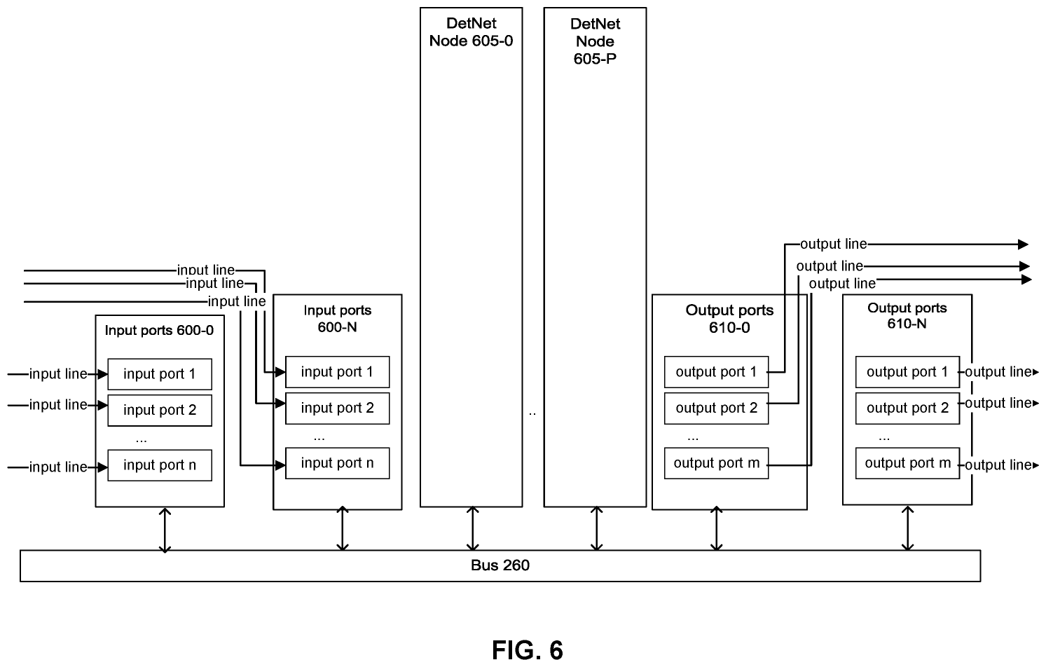

FIG. 6 depicts an example of scaling capacity on a single node. For an increasing volume of ingress traffic, a number of input ports 600-0 to 600-N, where N≥1, can be added and connected to bus 260. Similarly, for an increasing volume of ingress traffic, a number of DetNet nodes 605-0 to 605-P, where P≥1, can be added and connected to bus 260 to process ingress traffic. In some examples, a number of network interface devices (e.g., instances or copies of network interface device 210) connected to bus 260 can be increased for increasing volumes of ingress traffic. Conversely, for decreasing volume of ingress traffic, a number of input ports 600-0 to 600-N can be removed and disconnected from bus 260. Similarly, for a decreasing volume of ingress traffic, a number of DetNet nodes 605-0 to 605-P can be removed and disconnected from bus 260.

FIG. 7 depicts an example process. The process can be performed by an administrator or orchestrator in some examples. At 702, a DetNet node can be composed. For example, a DetNet node can be composed of a network interface device with hardware accelerated DetNet operations as well as hardware accelerated MPLS, TSN, and switching fabric operations coupled to one or more input ports and one or more output ports via a bus that provides deterministic or bounded upper limit of latency for communications. At 704, based on a scale up of DetNet traffic, one or more additional devices can be coupled to the bus, such as: one or more input ports, one or more network interface devices, one or more output ports, one or more processors, and one or more memory devices. In some examples, a cluster of DetNet nodes can be coupled together using a network or bus with deterministic latency (e.g., low-end bandwidth provided for QoS traffic). In some examples, traffic processed by different DetNet nodes can be load balanced. At 706, based on a scale down of DetNet traffic, one or more additional devices can be decoupled from the bus, such as: one or more input ports, one or more network interface devices, one or more output ports, one or more processors, and one or more memory devices.

FIG. 8 depicts an example network interface device or packet processing device. In some examples, the packet processing device can be programmed to perform operations of a DetNet node, as described herein. In some examples, packet processing device 800 can be implemented as a network interface controller, network interface card, a host fabric interface (HFI), or host bus adapter (HBA), and such examples can be interchangeable. Packet processing device 800 can be coupled to one or more servers using a bus, PCIe, CXL, or DDR. Packet processing device 800 may be embodied as part of a system-on-a-chip (SoC) that includes one or more processors, or included on a multichip package that also contains one or more processors.

Some examples of packet processing device 800 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values.

Processors 804 can be any a combination of a: processor, core, graphics processing unit (GPU), field programmable gate array (FPGA), application specific integrated circuit (ASIC), or other programmable hardware device that allow programming of network interface 800. For example, a “smart network interface” can provide packet processing capabilities in the network interface using processors 804.

Processors 804 can include one or more packet processing pipeline that can be configured to perform match-action on received packets to identify packet processing rules and next hops using information stored in a ternary content-addressable memory (TCAM) tables or exact match tables in some embodiments. A packet processing pipeline can include one or more circuitries that perform match-action operations in a pipelined or serial manner that are configured based on a programmable pipeline language instruction set. Processors, FPGAs, other specialized processors, controllers, devices, and/or circuits can be used utilized for packet processing or packet modification. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 804, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others. Processors 804 and/or system on chip 850 can perform DetNet, MPLS, and TSN services, as described herein.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

FIG. 9 depicts an example computing system that can be used in a server or data center. Components of system 900 (e.g., processor 910, accelerators 942, and so forth) to configure at least one DetNet node, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 generates an image or video or display or storage based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. For example, OS 932 can configure network interface 950 and/or other devices to perform operations of a DetNet node, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can perform operations to perform operations of a DetNet node, as described herein.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 can include volatile or non-volatile memory. A volatile memory is memory whose state (and therefore the data stored in it) is indeterminate if power is interrupted to the device. An example of a volatile memory include a cache. A non-volatile memory (NVM) device is a memory whose state is determinate even if power is interrupted to the device.

In an example, system 900 can be implemented using interconnected compute nodes of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, chiplet-to-chiplet communications, die-to-die communications, packet-based communications, communications over a device interface, fabric-based communications, and so forth. A die-to-die communications can be consistent with Embedded Multi-Die Interconnect Bridge (EMIB).

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus comprising: at least one network interface device that comprises circuitry to perform Deterministic Networking (DetNet) packet forwarding operations; at least one input port; at least one output port; and a bus that is to provide communications, at a quality of service (QoS), among the network interface device, the at least one input port, and the at least one output port, wherein a number of network interface devices, a number of input ports, and a number of output ports are based on an amount of DetNet traffic to process prior to transmission.

Example 2 includes one or more examples, wherein the DetNet packet forwarding operations are consistent at least with Internet Engineering Task Force (IETF) Request for Comment (RFC) 8655 (2019) and RFC 8938 (2020).

Example 3 includes one or more examples, wherein the circuitry to perform DetNet packet forwarding operations comprises circuitry to perform packet processing based on Multi-protocol Label Switching (MPLS) and Time-Sensitive Networking (TSN).

Example 4 includes one or more examples, wherein the circuitry to perform DetNet packet forwarding operations is configured using a configuration from a software-defined networking (SDN) controller.

Example 5 includes one or more examples, wherein the configuration comprises an Multi-protocol Label Switching (MPLS) routing table.

Example 6 includes one or more examples, wherein the bus is to operate consistent with one or more of: Peripheral Component Interconnect Express (PCIe), Compute Express Link (CXL), or Universal Chiplet Interconnect Express (UCIe).

Example 7 includes one or more examples, including at least one processor and at least one memory device, wherein a number of at least one processor and a number of at least one memory device is based on an amount of non-deterministic packet traffic.

Example 8 includes one or more examples, and includes a cluster comprising a first system that comprises the at least one network interface device that comprises circuitry to perform DetNet packet forwarding operations, the at least one input port, the at least one output port, and the bus and a second system that comprises: at least one network interface device that comprises circuitry to perform DetNet packet forwarding operations; at least one input port; at least one output port; and a bus that is to provide communications, at a QoS, among the network interface device, the at least one input port, and the at least one output port, wherein a load of DetNet packet traffic is allocated among the first and second systems.

Example 9 includes one or more examples, wherein the first and second systems are to perform operations of a Network Function Virtualization (NFV) or Service Function Chains (SFC).

Example 10 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

Example 11 includes one or more examples, wherein one or more of the number of network interface devices, the number of input ports, and/or the number of output ports are increased based on an increase in amount of DetNet traffic to process prior to transmission.

Example 12 includes one or more examples, wherein one or more of the number of network interface devices, the number of input ports, and/or the number of output ports are decreased based on a decrease in amount of DetNet traffic to process prior to transmission.

Example 13 includes one or more examples, wherein the number of network interface devices, the number of input ports, and the number of output ports are configured by an orchestrator.

Example 14 includes one or more examples, and includes a non-transitory computer-readable medium comprising instructions stored thereon, that if executed by one or more processors, cause the one or more processors to: control an amount of Deterministic Networking (DetNet) traffic to process prior to transmission by controlling a number of network interface devices, a number of input ports, and/or a number of output ports coupled to a bus, wherein at least one of the network interface devices performs DetNet packet forwarding operations.

Example 15 includes one or more examples, wherein the DetNet packet forwarding operations are consistent at least with Internet Engineering Task Force (IETF) Request for Comment (RFC) 8655 (2019) and RFC 8938 (2020).

Example 16 includes one or more examples, wherein at least one of the network interface devices performs DetNet packet forwarding operations based on Multi-protocol Label Switching (MPLS) and Time-Sensitive Networking (TSN).

Example 17 includes one or more examples, and includes a method that includes: adjusting device resources of a Deterministic Networking (DetNet) node to perform DetNet packet forwarding operations by adjusting a number of network interface devices, a number of input ports, and/or a number of output ports coupled to a bus, wherein the bus provides communications among the network interface devices, the input ports, and/or the output ports.

Example 18 includes one or more examples, wherein the device resources comprise at least one processor and at least one memory device and comprises: adjusting a number of processors and a number of memory devices based on an amount of non-deterministic packet traffic.

Example 19 includes one or more examples, wherein the DetNet packet forwarding operations are consistent at least with Internet Engineering Task Force (IETF) Request for Comment (RFC) 8655 (2019) and RFC 8938 (2020).

Example 20 includes one or more examples, wherein the DetNet packet forwarding operations are based on Multi-protocol Label Switching (MPLS) and Time-Sensitive Networking (TSN).

What is claimed is:

1. An apparatus comprising:
at least one network interface device that comprises circuitry to perform Deterministic Networking (DetNet) packet forwarding operations;
at least one input port;
at least one output port; and
a bus that is to provide communications, at a quality of service (QoS), among the network interface device, the at least one input port, and the at least one output port, wherein
a number of network interface devices, a number of input ports, and a number of output ports are based on an amount of DetNet traffic to process prior to transmission.

2. The apparatus of claim 1, wherein the DetNet packet forwarding operations are consistent at least with Internet Engineering Task Force (IETF) Request for Comment (RFC) 8655 (2019) and RFC 8938 (2020).

3. The apparatus of claim 1, wherein the circuitry to perform DetNet packet forwarding operations comprises circuitry to perform packet processing based on Multi-protocol Label Switching (MPLS) and Time-Sensitive Networking (TSN).

4. The apparatus of claim 1, wherein the circuitry to perform DetNet packet forwarding operations is configured using a configuration from a software-defined networking (SDN) controller.

5. The apparatus of claim 4, wherein the configuration comprises an Multi-protocol Label Switching (MPLS) routing table.

6. The apparatus of claim 1, wherein the bus is to operate consistent with one or more of: Peripheral Component Interconnect Express (PCIe), Compute Express Link (CXL), or Universal Chiplet Interconnect Express (UCIe).

7. The apparatus of claim 1, comprising at least one processor and at least one memory device, wherein a number of at least one processor and a number of at least one memory device is based on an amount of non-deterministic packet traffic.

8. The apparatus of claim 1, comprising a cluster comprising a first system that comprises the at least one network interface device that comprises circuitry to perform DetNet packet forwarding operations, the at least one input port, the at least one output port, and the bus and a second system that comprises:
at least one network interface device that comprises circuitry to perform DetNet packet forwarding operations;
at least one input port;
at least one output port; and
a bus that is to provide communications, at a QoS, among the network interface device, the at least one input port, and the at least one output port, wherein a load of DetNet packet traffic is allocated among the first and second systems.

9. The apparatus of claim 8, wherein the first and second systems are to perform operations of a Network Function Virtualization (NFV) or Service Function Chains (SFC).

10. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

11. The apparatus of claim 1, wherein one or more of the number of network interface devices, the number of input ports, and/or the number of output ports are increased based on an increase in amount of DetNet traffic to process prior to transmission.

12. The apparatus of claim 1, wherein one or more of the number of network interface devices, the number of input ports, and/or the number of output ports are decreased based on a decrease in amount of DetNet traffic to process prior to transmission.

13. The apparatus of claim 1, wherein the number of network interface devices, the number of input ports, and the number of output ports are configured by an orchestrator.

14. A non-transitory computer-readable medium comprising instructions stored thereon, that if executed by one or more processors, cause the one or more processors to:
control an amount of Deterministic Networking (DetNet) traffic to process prior to transmission by controlling a number of network interface devices, a number of input ports, and/or a number of output ports coupled to a bus, wherein at least one of the network interface devices performs DetNet packet forwarding operations.

15. The computer-readable medium of claim 14, wherein the DetNet packet forwarding operations are consistent at least with Internet Engineering Task Force (IETF) Request for Comment (RFC) 8655 (2019) and RFC 8938 (2020).

16. The computer-readable medium of claim 14, wherein at least one of the network interface devices performs DetNet packet forwarding operations based on Multi-protocol Label Switching (MPLS) and Time-Sensitive Networking (TSN).

17. A method comprising:
adjusting device resources of a Deterministic Networking (DetNet) node to perform DetNet packet forwarding operations by adjusting a number of network interface devices, a number of input ports, and/or a number of output ports coupled to a bus, wherein the bus provides communications among the network interface devices, the input ports, and/or the output ports.

18. The method of claim 17, wherein the device resources comprise at least one processor and at least one memory device and comprises:
adjusting a number of processors and a number of memory devices based on an amount of non-deterministic packet traffic.

19. The method of claim 17, wherein the DetNet packet forwarding operations are consistent at least with Internet Engineering Task Force (IETF) Request for Comment (RFC) 8655 (2019) and RFC 8938 (2020).

20. The method of claim 17, wherein the DetNet packet forwarding operations are based on Multi-protocol Label Switching (MPLS) and Time-Sensitive Networking (TSN).
